(19) United States
(12) Patent Application Publication
(10) Pub. No.: US 2012/0247518 A1
(43) Pub. Date: Oct. 4, 2012

(54) THIN PLATE MEMBER WASHING APPARATUS

(75) Inventors: Masayuki ESAKI, Ibaraki-shi (JP); Kei ASAI, Otsu-shi (JP); Kentaro MORI, Nara-shi (JP); Makoto TABATA, Kyoto-shi (JP); Yusaku SAKODA, Shiojiri-shi (JP); Toshiro FURUSAWA, Kyotanabe-shi (JP); Masao MAEDA, Kyoto-shi (JP); Yusuke KATO, Sunrise, FL (US)

(73) Assignee: OMRON HEALTHCARE CO., LTD., Muko-shi (JP)

(21) Appl. No.: 13/432,827

(22) Filed: Mar. 28, 2012

Related U.S. Application Data
(63) Continuation of application No. PCT/JP2010/073836, filed on Dec. 29, 2010.

(30) Foreign Application Priority Data
Jan. 8, 2010 (JP) 2010-003036

(51) Int. Cl. B08B 3/02

(52) U.S. Cl. 134/138

(57) ABSTRACT

In a thin plate member washing apparatus, tap water showering down from water flow holes of a water flow plate makes contact with outer rotary blades and inner rotary blades provided in a rotary supporting member, thereby rotating the rotary supporting member. Moreover, the tap water falling on a mesh member held by a mesh member holding portion flows over a front surface and a back surface of the mesh member based on a centrifugal force due to rotation of the mesh member and removes medicinal fluid residue deposited on the mesh member. The medicinal fluid residue removed from the mesh member is directly carried by the tap water and discharged to the outside of the thin plate member washing apparatus through a fluid outlet opening.

### TECHNICAL FIELD

The present invention relates to a thin plate member washing apparatus for washing a thin plate member.

### BACKGROUND ART

There is technology of vibrating a mesh member composed of a thin plate member made of metal or other materials in which multiple minute holes are formed and spraying fine particles of liquid. As a specific example, such technology is applied to atomizers (nebulizers or inhalers) used to administer drugs for asthma and the like by inhalation. It is desired that the mesh member is kept clean, especially in the case of nebulizers, because nebulizers are used for inhalation of medicinal fluid. Moreover, for example, in the case where a viscous medicinal fluid is used, washing after use is required so as to prevent clogging of the minute holes with the medicinal fluid sticking to the mesh member.

Typical examples of the method of washing the mesh member include: (a) a method of washing the mesh member by filling a medicinal fluid bottle of a nebulizer with tap water and spraying the tap water for a few minutes (washing by spraying water), (b) a method of washing the mesh member by shaking it in water collected in a washing vessel (in-vessel washing), and (c) a method of washing the mesh member by directly exposing a mesh portion to flowing tap water (washing with flowing water).

However, the method (a) of washing by spraying water consumes the battery of the nebulizer, resulting in a decrease in the time period before battery replacement is required. Care needs to be taken because it is undesirable for a user or other person to inhale the atomized water. Moreover, washing takes a lot of time and labor.

The in-vessel washing method (b) is inferior to the method (a) of washing by spraying water in terms of washing performance. The mesh member cannot be uniformly washed. Medicinal fluid residue and the like that have been removed are suspended in the washing vessel during washing, and therefore the medicinal fluid residue and the like may be redeposited on the mesh member.

In the case of the method (c) of washing with flowing water, when washing is performed by directly exposing the mesh portion to flowing tap water, the mesh member may be damaged and deformed as a result of exposure to a strong stream of flowing water, because the mesh member often is a thin plate so that micromachining can be performed and clogging can be prevented. There also is a risk that the force of the water may cause the mesh member to be dropped from the hand and the mesh member may be washed down the drain.

The background art of the thin plate member washing apparatus for washing a mesh member or the like according to the present invention has been described based on common technical information in the art that has become known to the applicant of the present invention, but as far as the applicant remembers, the applicant does not have any information that should be disclosed as prior art literature information before the filing of the present application. Note that a technology of washing rice or cereals using the force of flowing tap water is disclosed in Patent Literature 1 (JP 2001-178639A “Water Flow Type Rice Washer and Cereal Washer”) listed below, although this technology belongs to a technical field different from the thin plate member washing apparatus.

### CITATION LIST

### Patent Literature

Patent Literature 1: JP 2001-178639A

### SUMMARY OF INVENTION

### Technical Problem

Problems to be solved by the present invention are attributed to the non-existence of an apparatus for washing a thin plate member. Therefore, an object of the present invention is to provide a thin plate member washing apparatus that can efficiently wash a thin plate member without causing damage to the thin plate member.

### Solution to Problem

A thin plate member washing apparatus according to the present invention includes a housing that includes a fluid inlet opening through which a fluid can be introduced and a fluid outlet opening, a thin plate member holding portion that is housed inside the housing and holds a thin plate member whose surface can be washed with the fluid, and a rotary supporting member that is housed inside the housing, supports the thin plate member holding portion, and is rotated by the fluid passing therethrough.

In another form of the thin plate member washing apparatus, the rotary supporting member has rotary blades that obtain a rotational force from the fluid passing the rotary blades.

Another form of any of the above-described thin plate member washing apparatuses further includes a fluid flow rate regulator that regulates a flow rate of the fluid flowing to the rotary supporting member, between the fluid inlet opening and the thin plate member holding portion.

Another form of any of the above-described thin plate member washing apparatuses further includes a fluid path separator that divides the fluid flowing to, the rotary supporting member into a plurality of streams, between the fluid inlet opening and the thin plate member holding portion.

Another form of any of the above-described thin plate member washing apparatuses further includes a fluid path spreader that spreads the fluid flowing to the rotary supporting member, between the fluid inlet opening and the thin plate member holding portion.

In another form of any of the above-described thin plate member washing apparatuses, a water tap can be connected to the fluid inlet opening.

In another form of any of the above-described thin plate member washing apparatuses, the thin plate member is a mesh member composed of a metal thin plate member in which multiple minute holes are formed.

### Advantageous Effects of Invention

With the thin plate member washing apparatus according to the present invention, it is possible to provide a thin plate member washing apparatus that can efficiently wash a thin plate member without causing damage to the thin plate member.

### BRIEF DESCRIPTION OF DRAWINGS

FIG. 1 is a first perspective view showing an overall configuration of a nebulizer including a mesh member.

FIG. 2 is a second perspective view showing the overall configuration of the nebulizer including the mesh member.

FIGS. 3(A) and 3(B) are partial cross-sectional views as viewed from arrows III-III in FIG. 2.

FIG. 4 is a perspective view showing an external configuration of a thin plate member washing apparatus of Embodiment 1.

FIG. 5 is an exploded perspective view showing the configuration of the thin plate member washing apparatus of Embodiment 1.

FIG. 6 is a perspective view showing an arrangement of mesh members and a rotary supporting member that is employed in the thin plate member washing apparatus of Embodiment 1.

FIG. 7 is a first perspective view showing the rotary supporting member that is employed in the thin plate member washing apparatus of Embodiment 1.

FIG. 8 is a second perspective view showing the rotary supporting member that is employed in the thin plate member washing apparatus of Embodiment 1.

FIG. 9 is a vertical cross-sectional view of the thin plate member washing apparatus of Embodiment 1.

FIG. 10 is an exploded perspective view showing the configuration of a thin plate member washing apparatus of Embodiment 2.

FIG. 11 is a perspective view showing an arrangement of a mesh member and a rotary supporting member that is employed in the thin plate member washing apparatus of Embodiment 2.

FIG. 12 is a vertical cross-sectional view of the thin plate member washing apparatus of Embodiment 2.

FIG. 13 is an exploded perspective view showing the configuration of a thin plate member washing apparatus of Embodiment 3.

FIG. 14 is a perspective view showing an arrangement of a mesh member and a rotary supporting member that is employed in the thin plate member washing apparatus of Embodiment 3.

FIG. 15 is a vertical cross-sectional view of the thin plate member washing apparatus of Embodiment 3.

FIG. 16 is an exploded perspective view showing the configuration of a thin plate member washing apparatus of Embodiment 4.

FIG. 17 is a perspective view showing an arrangement of a mesh member and a rotary supporting member that is employed in the thin plate member washing apparatus of Embodiment 4:

FIG. 18 is a vertical cross-sectional view of the thin plate member washing apparatus of Embodiment 4.

### DESCRIPTION OF EMBODIMENTS

Hereinafter, thin plate member washing apparatuses of embodiments according to the present invention will be described in detail with reference to the drawings. Note that in the ease where a number, amount, or the like is mentioned in an embodiment described below, it is to be understood that the scope of the present invention is not necessarily limited to such a number, amount, or the like, unless otherwise stated. Moreover, in the case where a plurality of embodiments are described below, it is to be understood that it is planned to appropriately combine the individual embodiments, unless otherwise stated. The same reference numerals in the drawings indicate the same or corresponding portions, and redundant descriptions thereof may be omitted.

The thin plate member washing apparatuses of the embodiments that will be described later are shown in a state in which the thin plate member washing apparatuses are directly connected to a water tap. However, the present invention is not limited to the structure in which a thin plate member washing apparatus is directly connected to a tap, and a hose can be interposed between the thin plate member washing apparatus and the tap, or the thin plate member washing apparatus can be connected to a bottle or the like storing a dedicated washing liquid. Since the structure of a tap is a well-known technology, the internal structure of the tap is omitted from the drawings.

Nebulizer Including Mesh Member

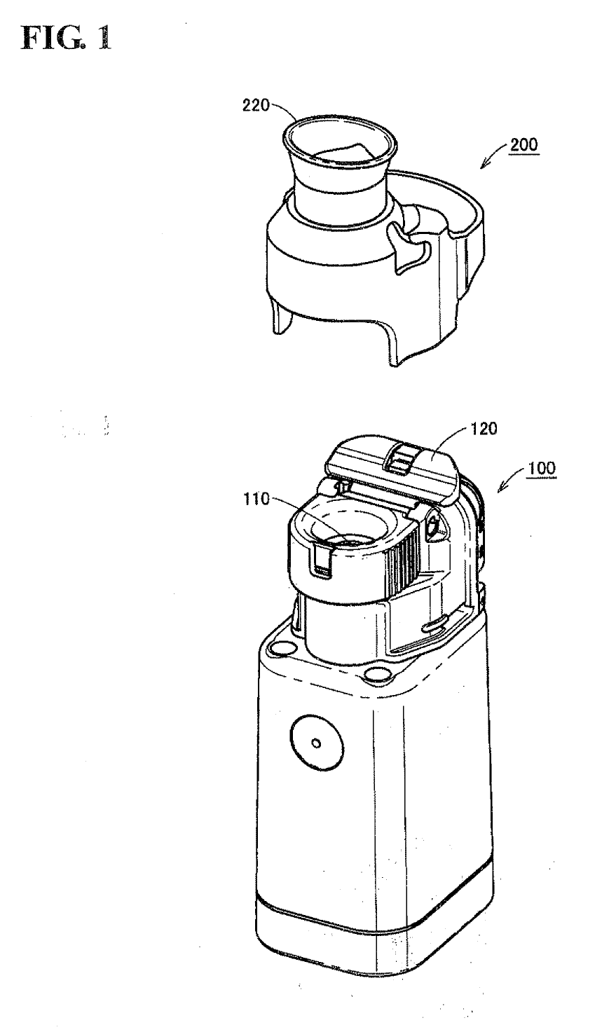

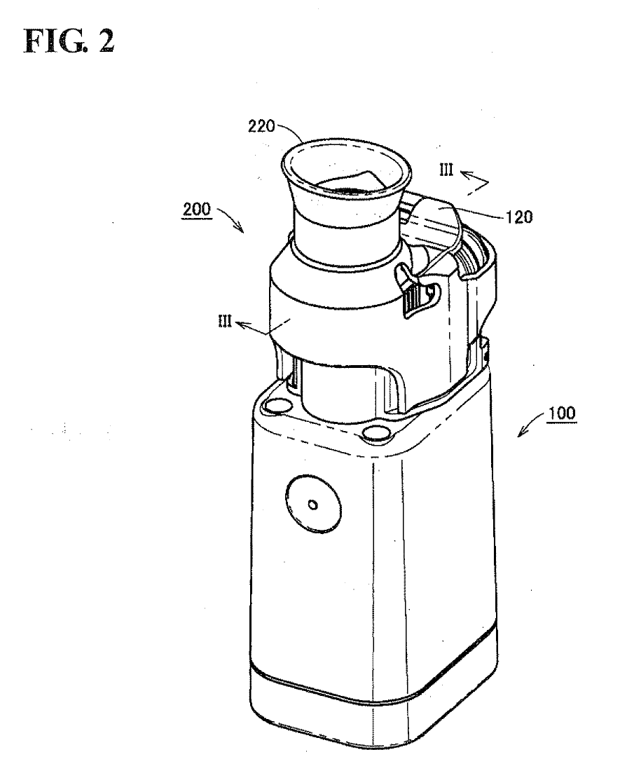

A nebulizer including a mesh member serving as an example of a member to be washed will be described first with reference to FIGS. 1 to 3. Nebulizers are devices that are used mainly for medical purposes. An atomization portion of a nebulizer atomizes a medicinal fluid into a mist of particles, and the user inhales the mist of the medicinal fluid through his/her mouth or nose for treatment of a disease in the bronchus, nasal cavity, throat, or the like.

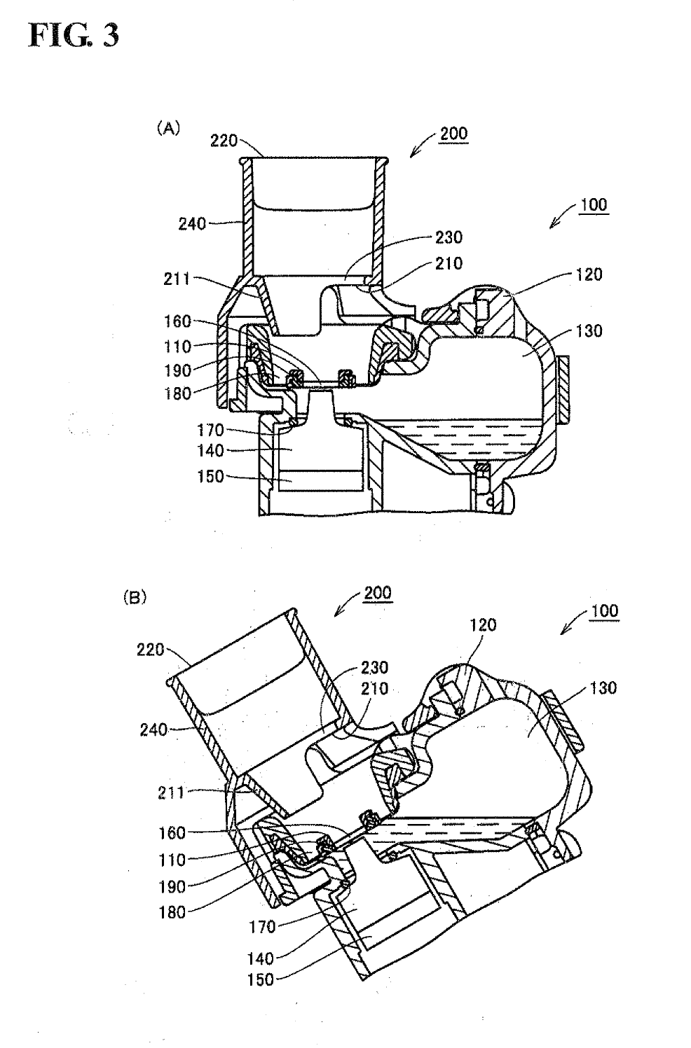

A nebulizer 100 shown in the drawings includes an ultrasonic mesh atomization mechanism. The nebulizer 100 includes a nozzle 110 for spraying the medicinal fluid on top of the atomization mechanism. Moreover, an open/close operation portion 120 for supplying the medicinal fluid into a medicinal fluid storage portion 130 (see FIG. 3) within the nebulizer 100 and facilitating washing of the medicinal fluid storage portion 130 is provided in an upper portion of the nebulizer 100. The medicinal fluid can also be supplied by opening and closing the nozzle 110.

A mouthpiece 200 serving as an inhalation aid for the nebulizer 100 is integrally formed from a resin material. The mouthpiece 200 has a shape that enables attachment to the top of the nebulizer 100, and includes a tubular portion 240 (see FIG. 3) inside, through which the mist of the medicinal fluid sprayed from the nozzle 110 of the nebulizer 100 passes.

An inhalation port 220 serving as a second opening to be held in the user's mouth is provided in an upper surface of the mouthpiece 200. The tubular portion 240 of the mouthpiece 200 has an air intake 230 serving as a third opening for taking in air at a predetermined position, rather than being attached to the nozzle 110 of the nebulizer 100 in an airtight manner.

The user uses the nebulizer 100 held in his/her hand in a state in which the mouthpiece 200 is attached to the top of the nebulizer 100. At this time, the user slightly tilts the nebulizer 100 toward him/her and holds the inhalation port 220 of the mouthpiece 200 in his/her mouth.

Next, the structure of the nebulizer 100 and the shape of the mouthpiece 200 will be described in further detail with reference to FIGS. 3(A) and 3(B). FIG. 3 (A) shows a state in which the nebulizer 100 is kept in a horizontal position, and FIG. 3 (B) shows a state in which the user has tilted the nebulizer 100 toward him/her to use the nebulizer 100.

The nebulizer 100 includes the ultrasonic mesh atomization mechanism immediately under the nozzle 110. The ultrasonic mesh atomization mechanism is composed of a piezoelectric element 150, a stepped horn 140, and a mesh member 160. The mesh member 160 has a metal thin plate member in which multiple minute holes are formed and a resin member provided around the thin plate member. A lower surface of the mesh member 160 is in contact with an end of the stepped horn 140. The mesh member 160 is detachably attached to a partition plate 190 so as to enable the user to detach it for washing.

The piezoelectric element 150 starts vibrating when driven by a power supply. The vibration propagates to the stepped horn 140, causing the medicinal fluid to be atomized at a contact surface between the stepped horn 140 and the mesh member 160. The atomized medicinal fluid is ejected from the minute holes toward the nozzle 110 of the nebulizer 100 with great force.

A fluid collecting portion 180 for storing the medicinal fluid that has been deposited on the tubular portion 240 and hence become liquid droplets and saliva that runs from the user's mouth is formed along a peripheral edge of the nozzle 110. The medicinal fluid and the saliva stored in the fluid collecting portion 180 are isolated by the partition plate 190 so as not to enter the mesh member 160 located on the inside of the fluid collecting portion 180.

The medicinal fluid storage portion 130 adjoining to the atomization portion is formed inside the nebulizer 100. The medicinal fluid is replenished by opening and closing the aforementioned nozzle 110. As a result of the nebulizer 100 being tilted during use, all of the medicinal fluid stored in the medicinal fluid storage portion 130 is supplied to the atomization portion and atomized. For this reason, the atomization portion has a watertight structure with an O-ring 170 in order to prevent the medicinal fluid from dripping into the apparatus.

As described above, the mouthpiece 200 includes the tubular portion 240 through which the atomized medicinal fluid passes and includes, at opposite ends of the tubular portion 240, an atomizer-side opening 210 serving as a first opening that faces the nozzle 110 of the nebulizer 100 in a state in which the mouthpiece 200 is attached to the nebulizer 100 and the inhalation port 220 serving as the second opening to be held in the user's mouth.

A flange portion 211 contiguous with the tubular portion 240 extends from a portion of the peripheral edge of the atomizer-side opening 210. The flange portion 211 has a function of collecting and guiding the medicinal fluid that has become liquid droplets and the saliva into the fluid collecting portion 180 of the nebulizer 100 so as to prevent dripping of such liquid.

The flange portion 211 is not provided along the entire peripheral edge of the opening lest the tubular portion 240 is made airtight, but rather the air intake 230 for taking in air is formed in a portion of the peripheral edge of the atomizer-side opening where the flange portion is not formed. The air intake 230 is formed by cutting the atomizer-side opening. Thus, airflow is constantly generated in the tubular portion 240.

### Embodiment 1

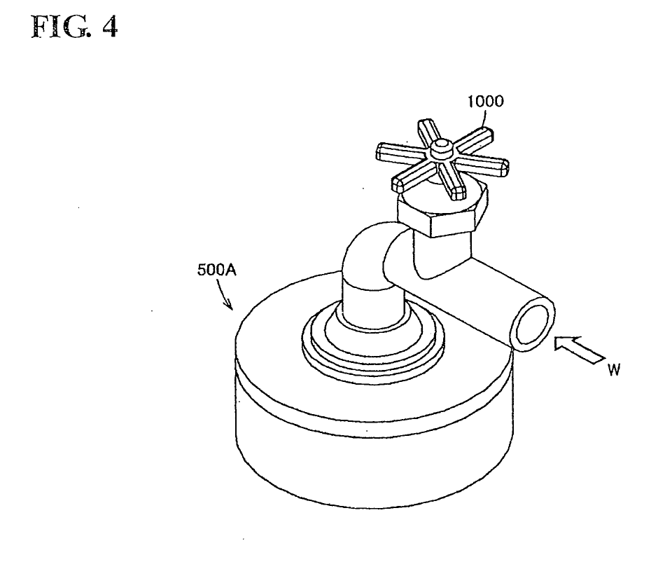

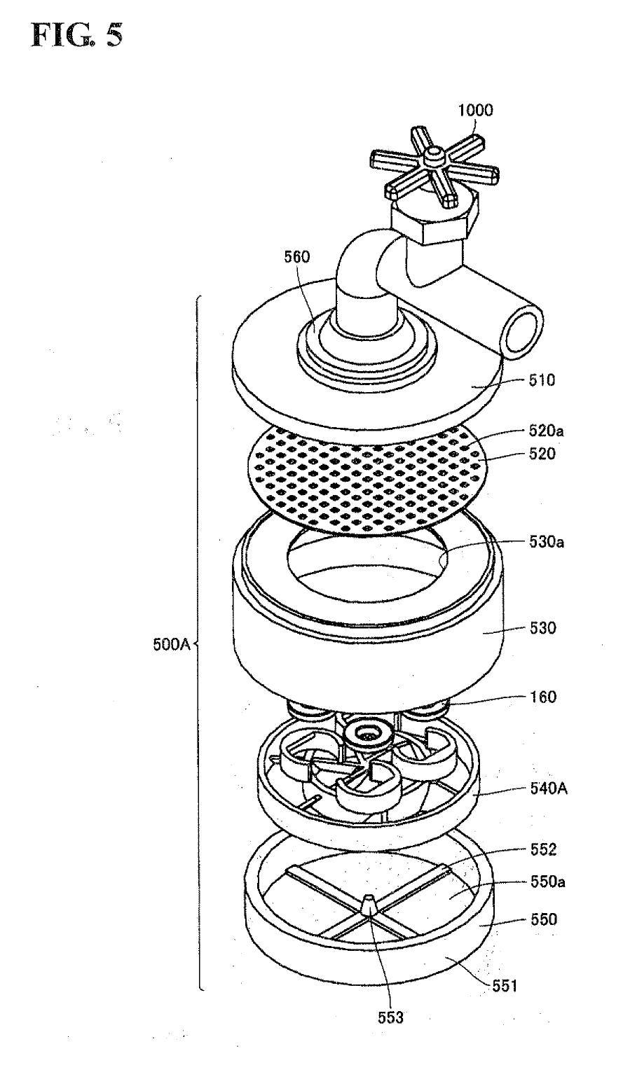

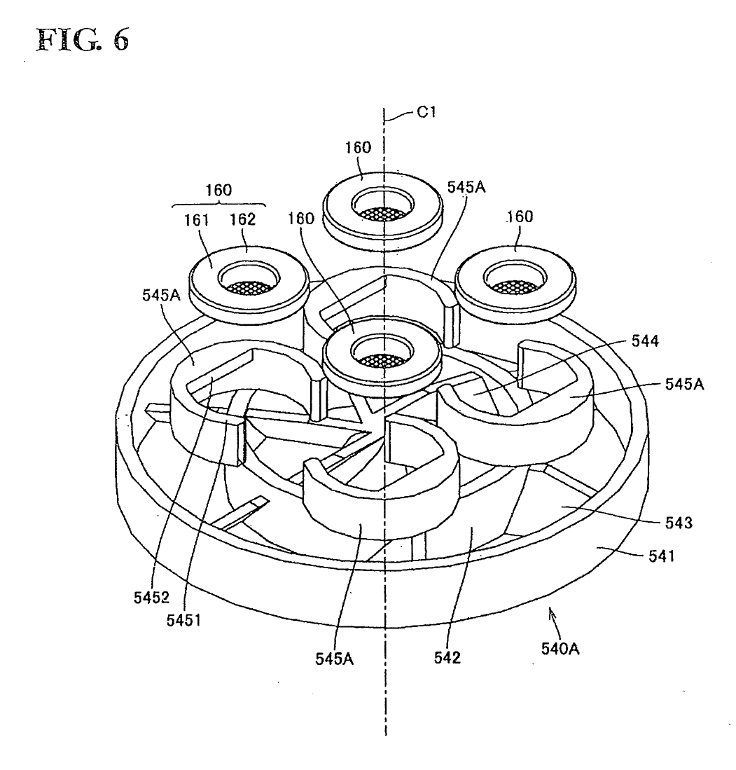

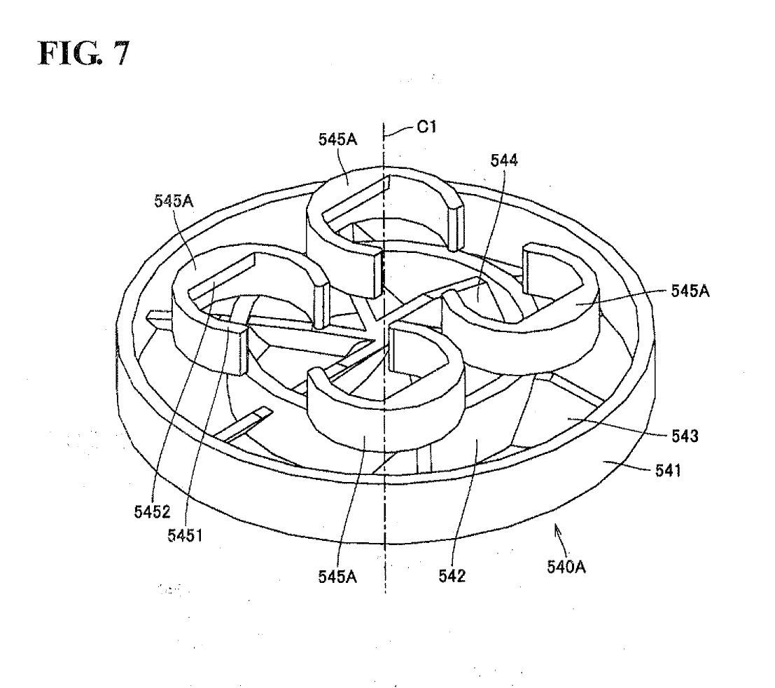

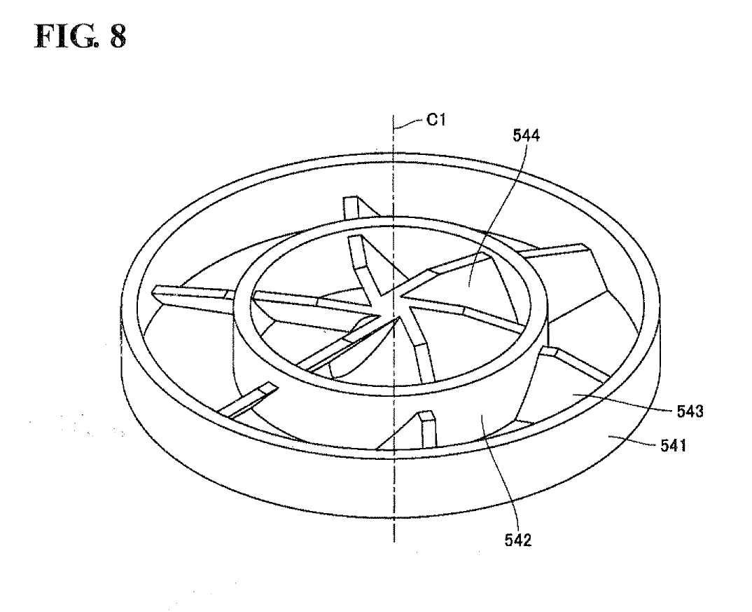

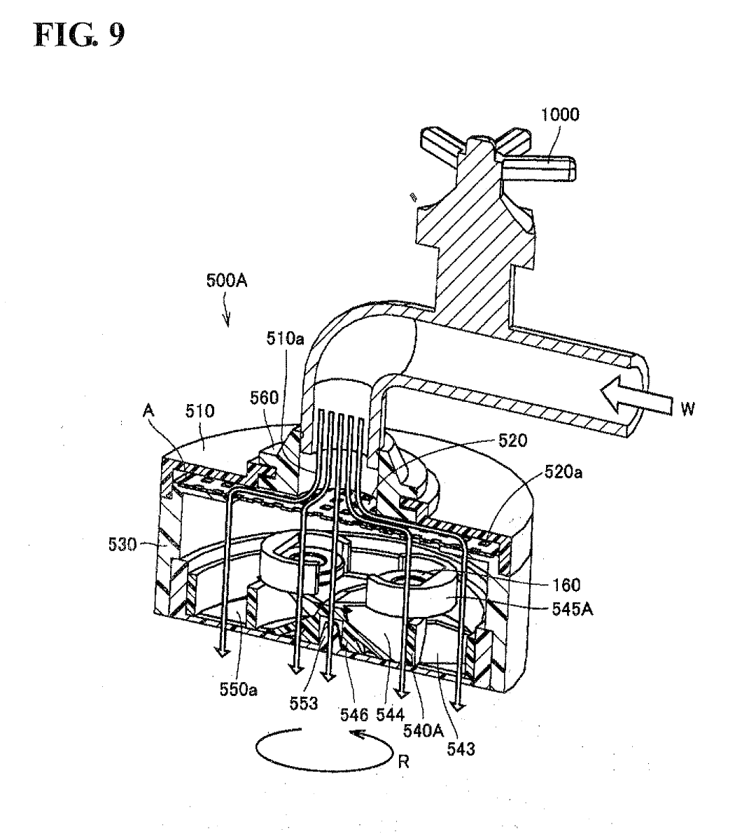

Next, the structure of a thin plate member washing apparatus 500A of Embodiment 1 according to the present invention will be described with reference to FIGS. 4 to 9. FIG. 4 is a perspective view showing an external configuration of the thin plate member washing apparatus 500A, FIG. 5 is an exploded, perspective view showing the configuration of the thin plate member washing apparatus 500A, FIG. 6 is a perspective view showing an arrangement of mesh members and a rotary supporting member that is employed in the thin plate member washing apparatus 500A, FIG. 7 is a first perspective view showing the rotary supporting member that is employed in the thin plate member washing apparatus 500A, FIG. 8 is a second perspective view showing the rotary supporting member that is employed in the thin plate member washing apparatus 500A, and FIG. 9 is a vertical cross-sectional view of the thin plate member washing apparatus 500A.

Thin Plate Member Washing Apparatus 500A

The thin plate member washing apparatus 500A is shown in a state in which it is connected to a water tap 1000. As can be clearly seen in FIG. 5, the thin plate member washing apparatus 500A has a circular lid 510 to which the tap 1000 can be joined, a circular water flow plate 520 that is disposed under the lid 510, an approximately cylindrical cap 530 that is disposed under the water flow plate 520 and has an opening 530a in its center, a circular rotary supporting member 540A that is disposed so as to be housed inside the cap 530, and a circular bottom cap 550 that has a rotation shaft 553 that rotatably supports the rotary supporting member 540A from underneath. The lid 510, the cap 530, and the bottom cap 550 constitute a housing that houses the water flow plate 520 and the rotary supporting member 540A inside.

Lid 510/Water Flow Plate 520

The lid 510 has a fluid inlet opening 510a in its center, and a rubber gasket 560 to which the tap 1000 can be joined is fitted in the fluid inlet opening 510a. The water flow plate 520 is provided with a plurality of water flow holes 520a to divide a flow of tap water into a plurality of streams and spread the flow of tap water while regulating the flow rate of the tap water, and in a state in which the thin plate member washing apparatus 500A has been assembled, a space A for allowing tap water to flow through is formed between an inner surface side of the lid 510 and an upper surface of the water flow plate 520 (see FIG. 9). Note that a plate for regulating the flow rate of tap water, a plate for dividing a flow of tap water into a plurality of streams, and a plate for spreading the flow of tap water may be separately provided.

Rotary Supporting Member 540A

As shown in FIGS. 6 to 8, the rotary supporting member 540A has an outer circumferential ring-shaped side wall 541 and an inner circumferential ring-shaped side wall 542, and a plurality of outer rotary blades 543 are provided between the outer circumferential ring-shaped side wall 541 and the inner circumferential ring-shaped side wall 542. A plurality of inner rotary blades 544 are provided inside the inner circumferential ring-shaped side wall 542. A central axis of rotation C1 of the inner rotary blades 544 serves as an axis of rotation of the rotary supporting member 540A. The number of the outer rotary blades 543 and the inner rotary blades 544 and the tilt angle of those blades are chosen as appropriate. Moreover, a rotation shaft receiving recess 546 (see FIG. 9) that receives the rotation shaft 553, which will be described later, provided on the bottom cap 550 is provided at the center of the inner rotary blades 544 on a back surface side thereof.

Mesh member holding portions 545A for holding mesh members 160 are provided in four positions on an upper surface side of the inner circumferential ring-shaped side wall 542. The mesh members 160 are each composed of a metal thin plate member 161 in which multiple minute holes are formed and an annular resin member 162 integrally provided around the thin plate member 161.

The mesh member holding portions 545A each hold the mesh member 160 from the side and have a partially discontinuous ring portion 5451 and a retaining portion 5452 that holds the mesh member 160 from the upper surface side. Although the mesh member holding portions 545A are provided in four positions, they can be provided in a plurality of, for example, two, three, or five positions.

The mesh members 160 are each held in such a position that a plane containing the mesh member 160 is perpendicular to the central axis of rotation C1 of the inner rotary blades 544. When the central axis of rotation C1 extends in a vertical direction, the plane containing the mesh member 160 lies horizontally.

Bottom Cap 550

Referring again to FIG. 5, the bottom cap 550 has a ring-shaped side wall 551, and bridges 552 that form a cross shape are provided on the inside of the ring-shaped side wall 541. Gaps between the bridges 552 define a fluid outlet opening 550a from which tap water can be discharged to the outside. Moreover, the rotation shaft 553 serving as the central axis of rotation C1 of the rotary supporting member 540A is provided in a central portion at the intersection of the bridges 552.

Washing of Mesh Member 160

Next, washing of the mesh members 160 using the thin plate member washing apparatus 500A will be described with reference to FIG. 9. FIG. 9 is a cross-sectional view of the thin plate member washing apparatus 500A in a state in which it has been assembled. Tap water (arrow W in FIG. 9) poured from the tap 1000 is introduced into the thin plate member washing apparatus 500A through the fluid inlet opening 510a. The tap water making contact with the water flow plate 520 is spread out in the space A formed between the inner surface side of the lid 510 and the upper surface of the water flow plate 520.

The flow rate of the tap water flowing to the rotary supporting member 540A side is regulated by the number of water flow holes 520a provided in the water flow plate 520, and the flow of the tap water is divided into a plurality of streams, so that the flow of the tap water is spread over the entire surface of the water flow plate 520. Thus, the tap water showers down on the entire surface of the rotary supporting member 540A from the water flow holes 520a of the water flow plate 520. Moreover, the tap water, as a result of passing through the water flow holes 520a, takes in air, and bubbles containing air bubbles form. It can be expected that an impact of the air bubbles contained in the bubbles on the mesh members 160 and the energy released when the air bubbles burst enhance the washing effect.

The tap water showering down from the water flow holes 520a of the water flow plate 520 makes contact with the outer rotary blades 543 and the inner rotary blades 544 provided in the rotary supporting member 540A, thereby rotating the rotary supporting member 540A. The tap water falling on the mesh members 160 held by the mesh member holding portions 545A flows over a front surface and a back surface of the mesh members 160 based on a centrifugal force due to rotation of the mesh members 160 and removes medicinal fluid residue and the like deposited on the mesh members 160. The medicinal fluid residue and the like removed from the mesh members 160 are directly carried by the tap water and discharged to the outside of the thin plate member washing apparatus 500A through the fluid outlet opening 550a.

Effects

As described above, with the thin plate member washing apparatus 500A according to the present embodiment, the mesh members 160 are washed by utilizing the force of flowing tap water to cause the tap water to shower down on the mesh members 160 while rotating the mesh members 160. Thus, the tap water can uniformly flow over the surface of the mesh members 160, and therefore, the mesh members 160 can be uniformly, efficiently, and easily washed. Moreover, quantitative and more uniform washing can be achieved by predetermining the tap water flow rate and the washing time.

Since the force of flowing tap water is utilized, the mesh members 160 can be rotated without using any other power. Moreover, since the removed medicinal fluid residue and the like are discharged to the outside along with the flowing water, the medicinal fluid residue and the like cannot be redeposited on the mesh members 160.

Moreover, water from the water tap does not directly strike the mesh members 160 and, therefore, cannot damage the mesh members 160, especially the metal thin plate members 161. Moreover, the mesh members 160 are held by the mesh member holding portions 545A provided inside the thin plate member washing apparatus 500A and, therefore, cannot be carried down the drain by the tap water and lost.

As described above, with the thin plate member washing apparatus 500A of the present embodiment, it is possible to efficiently wash a mesh member 160 without causing damage to the mesh member 160.

### Embodiment 2

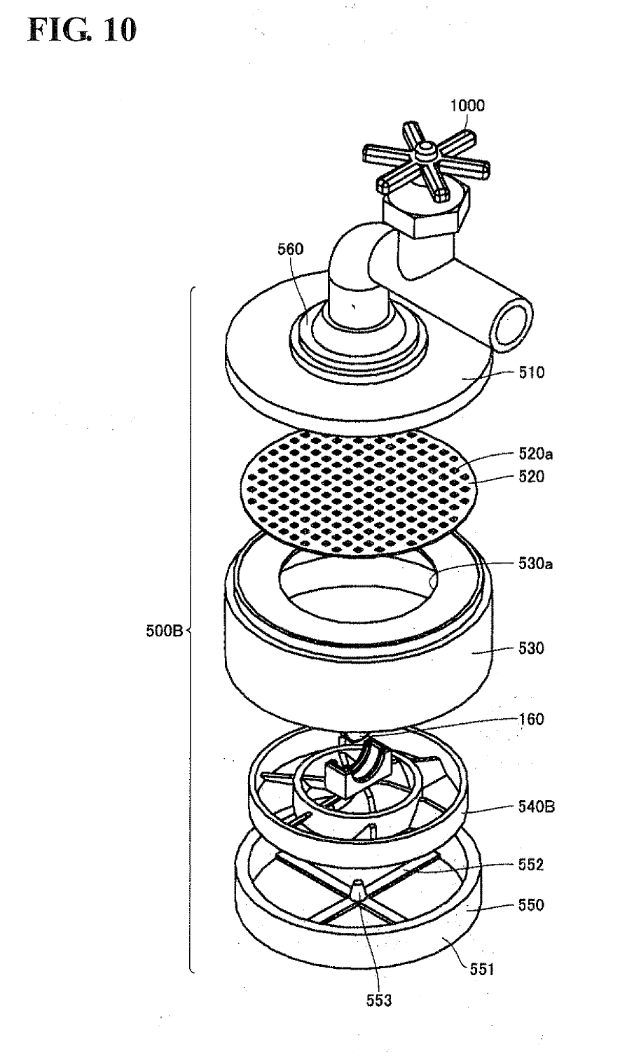

Next, the structure of a thin plate member washing apparatus 500B of Embodiment 2 according to the present invention will be described with reference to FIGS. 10 to 12. The thin plate member washing apparatus 500B of Embodiment 2 has the same basic configuration as the above-described thin plate member washing apparatus 500A of Embodiment 1. The two apparatuses are different in the form of the mesh member holding portion fixed to the rotary supporting member.

For this reason, in the drawings, the same components are denoted by the same reference numerals and duplication is eliminated, and only a mesh member holding portion 545B that is fixed to a rotary supporting member 540B employed in the thin plate member washing apparatus 500B of the present embodiment will be described.

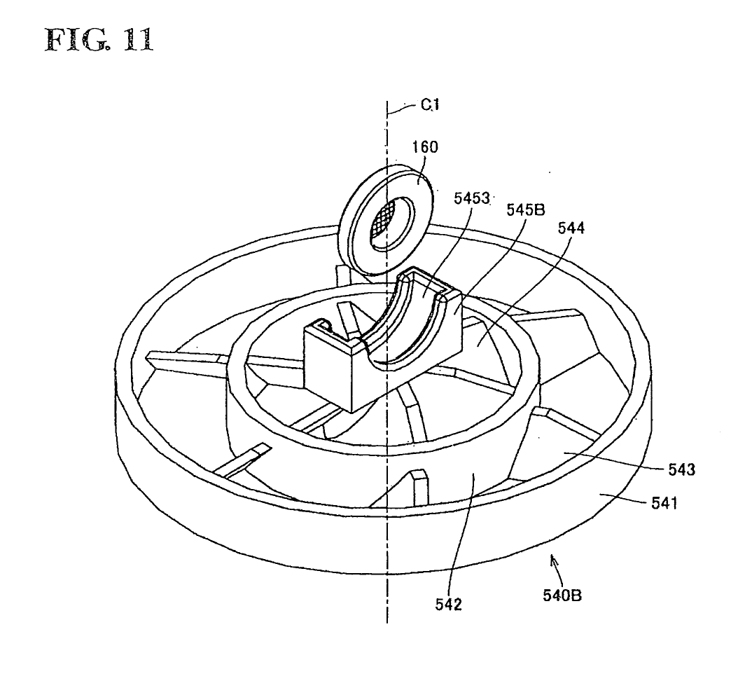

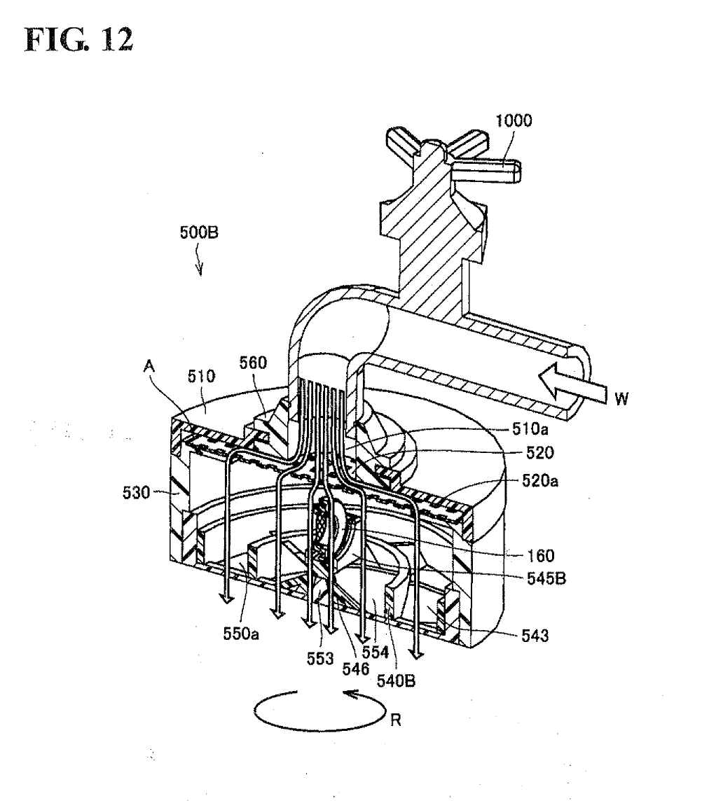

FIG. 10 is an exploded perspective view showing the configuration of the thin plate member washing apparatus 500B, FIG. 11 is a perspective view showing an arrangement of a mesh member and a rotary supporting member that is employed in the thin plate member washing apparatus 500B, and FIG. 12 is a vertical cross-sectional view of the thin plate member washing apparatus 500B.

Thin Plate Member Washing Apparatus 500B/Mesh Member Holding Portion 545B

As shown in FIGS. 10 and 11, in the rotary supporting member 540B of the present embodiment, a mesh member holding portion 545B for holding a mesh member 160 in a state in which it is in an upright position is provided on the upper surface side of the inner rotary blades 544 at the center of the rotary supporting member 540B. The state in which the mesh member 160 is in the upright position refers to a case where a plane containing the mesh member 160 and the central axis of rotation C1 of the rotary supporting member 540B are parallel to each other.

The mesh member holding portion 545B has a semicircular groove portion 5453 that holds the mesh member 160 from the lower lateral side in a state in which the mesh member 160 is in an upright position. The number of mesh member holding portions 545B is not limited to one, and two or more mesh member holding portions can be provided. For example, as described in Embodiment 1 above, it is also possible to dispose four mesh member holding portions 545B on the rotary supporting member 540B.

Washing of Mesh Member 160

Next, washing of the mesh member 160 using the thin plate member washing apparatus 500B will be described with reference to FIG. 12. FIG. 12 is a cross-sectional view of the thin plate member washing apparatus 500B in a state in which it has been assembled. Tap water (arrow W in FIG. 12) poured from the tap 1000 makes contact with the water flow plate 520 and is then spread out in the space A formed between the inner surface side of the lid 510 and the upper surface of the water flow plate 520.

The flow rate of the tap water flowing to the rotary supporting member 540B side is regulated by the number of water flow holes 520a provided in the water flow plate 520, and the flow of the tap water is divided into a plurality of streams, so that the flow of the tap water is spread over the entire surface of the water flow plate 520. Thus, the tap water showers down on the entire surface of the rotary supporting member 54013 from the water flow holes 520a of the water flow plate 520.

The tap water showering down from the water flow holes 520a of the water flow plate 520 makes contact with the outer rotary blades 543 and the inner rotary blades 544 provided in the rotary supporting member 540B, thereby rotating the rotary supporting member 540B. The tap water falling on the mesh member 160 held by the mesh member holding portion 54513 flows over the front surface and the back surface of the mesh member 160 and washes down medicinal fluid residue and the like deposited on the mesh member 160. The medicinal fluid residue and the like deposited on the mesh member 160 are also washed down based on the centrifugal force due to rotation of the mesh member 160. The medicinal fluid residue and the like removed from the mesh member 160 are directly carried by the tap water and discharged to the outside of the thin plate member washing apparatus 500B through the fluid outlet opening 550a.

Effects

As described above, with the thin plate member washing apparatus 500B of the present embodiment, the mesh member 160 is washed by utilizing the force of flowing tap water to cause the tap water to shower down on the mesh member 160 while rotating the mesh member 160 as well. Thus, the tap water can uniformly flow over the surface of the mesh member 160, and therefore, the mesh member 160 can be uniformly, efficiently, and easily washed. Moreover, quantitative and more uniform washing can be achieved by predetermining the tap water flow rate and the washing time.

Since the force of flowing tap water is utilized, the mesh member 160 can be rotated without using any other power. Moreover, since the removed medicinal fluid residue and the like are discharged to the outside along with the flowing water, the medicinal fluid residue and the like cannot be redeposited on the mesh member 160.

Moreover, water from the water tap does not directly strike the mesh member 160 and, therefore, cannot damage the mesh member 160, especially the metal thin plate member 161. Moreover, the mesh member 160 is held by the mesh member holding portion 545B that is provided inside the thin plate member washing apparatus 500B and, therefore, cannot be carried by the tap water down the drain and lost.

As described above, with the thin plate member washing apparatus 500B of the present embodiment, it is possible to efficiently wash a mesh member 160 without causing damage to the mesh member 160.

### Embodiment 3

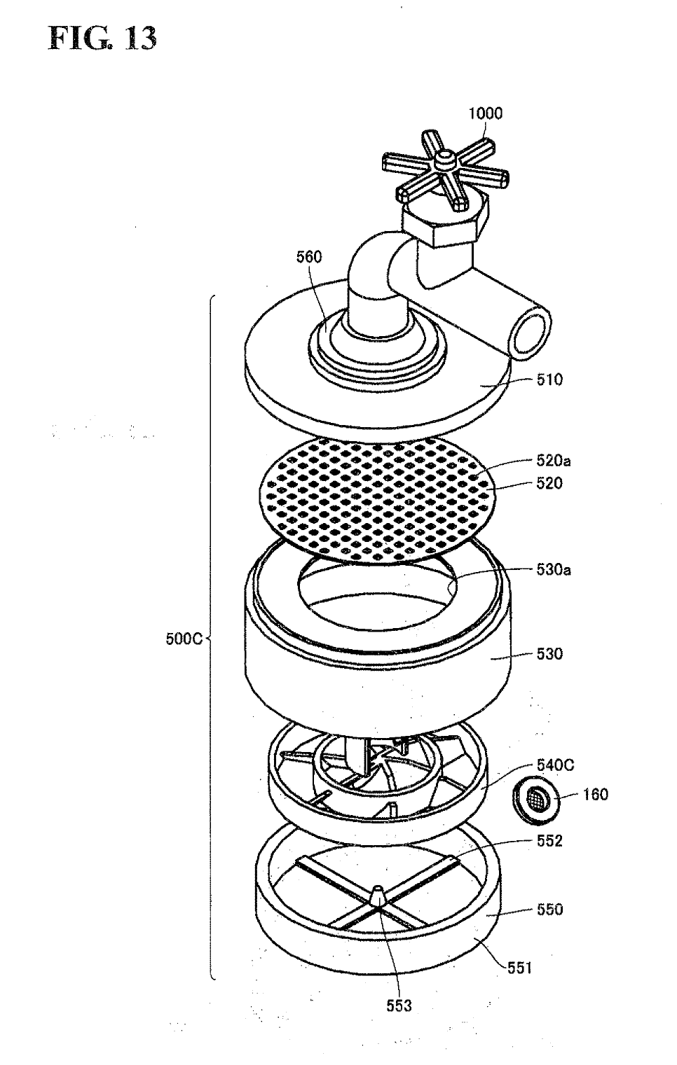

Next, the structure of a thin plate member washing apparatus 500C of Embodiment 3 according to the present invention will be described with reference to FIGS. 13 to 15. The thin plate member washing apparatus 500C of Embodiment 3 has the same basic configuration as the above-described thin plate member washing apparatus 500A of Embodiment 1. The two apparatuses are different in the form of the mesh member holding portion fixed to the rotary supporting member.

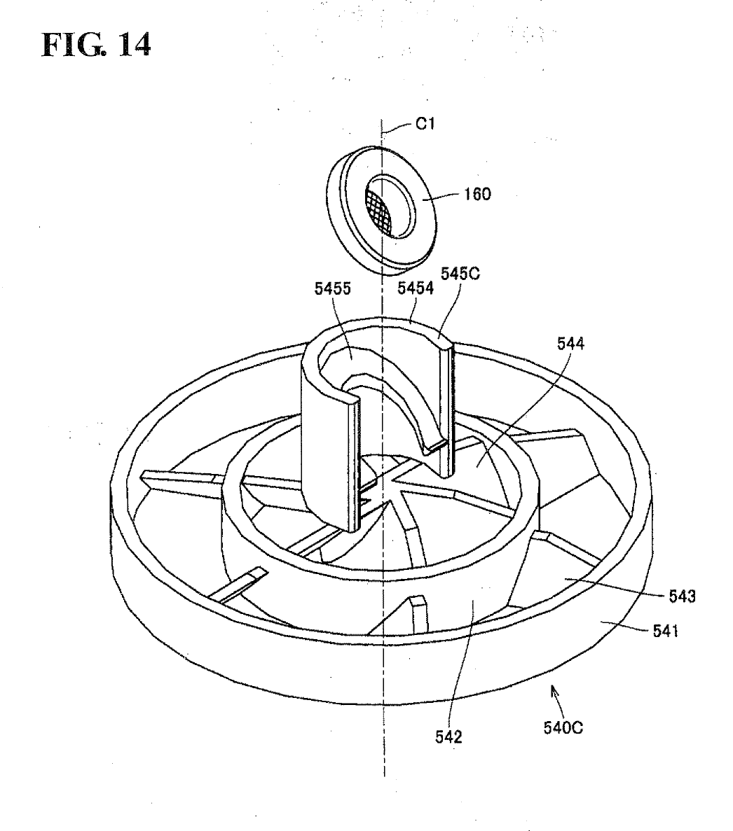

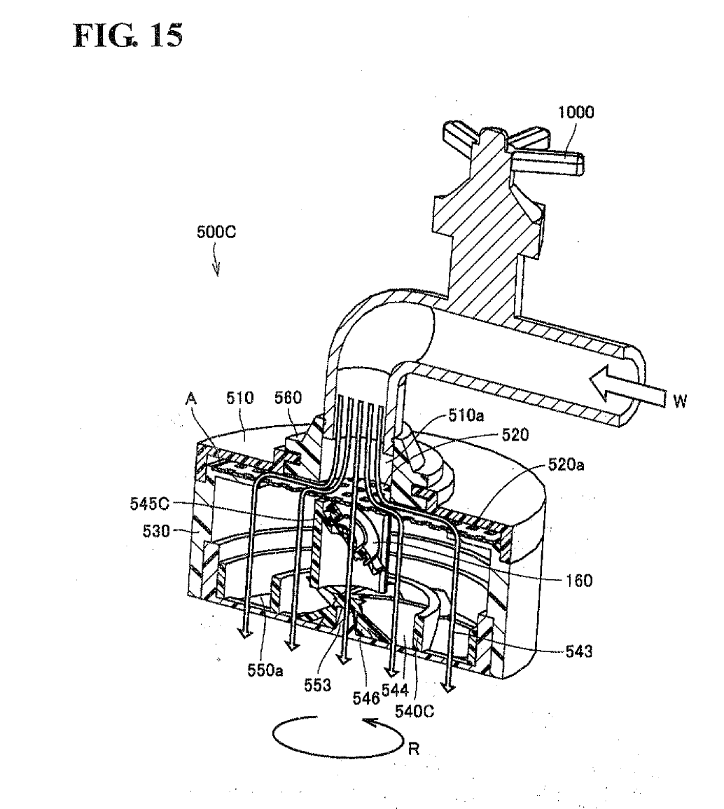

For this reason, in the drawings, the same components are denoted by the same reference numerals and duplication is eliminated, and only a mesh member holding portion 545C that is fixed to a rotary supporting member 540C employed in the thin plate member washing apparatus 500C of the present embodiment will be described. FIG. 13 is an exploded perspective view showing the configuration of the thin plate member washing apparatus 500C, FIG. 14 is a perspective view showing an arrangement of a mesh member and a rotary supporting member employed in the thin plate member washing apparatus 500C, and FIG. 15 is a vertical cross-sectional view of the thin plate member washing apparatus 500C.

Thin Plate Member Washing Apparatus 500C/Mesh Member Holding Portion 545C

As shown in FIGS. 13 and 14, in the rotary supporting member 540C of the present embodiment, the mesh member holding portion 545C for holding a mesh member 160 in a state in which it is in a sloping position is provided on the upper surface side of the inner rotary blades 544 at the center of the rotary supporting member 540C. Note that the state in which the mesh member 160 is in a sloping position refers to a state in which a plane containing the mesh member 160 intersects the central axis of rotation C1 of the rotary supporting member 540C. In Embodiment 1, the plane containing the mesh member 160 perpendicularly intersects the central axis of rotation C1 of the rotary supporting member 540A, and the state of the present embodiment means an intermediate state between the states of Embodiments 1 and 2.

The mesh member holding portion 545C has an approximately tubular side wall portion 5454 that covers the mesh member 160 from the side and that is partially cut out, and an approximately semicircular sloping support portion 5455 that is provided on an inner surface of the side wall portion 5454 and that holds the mesh member 160 in a sloping position from the lower lateral side. The number of mesh member holding portions 545C is not limited to one, and two or more mesh member holding portions can be provided. For example, as described in Embodiment 1 above, it is also possible to dispose four mesh member holding portions 545C.

Washing of Mesh Member 160

Next, washing of the mesh member 160 using the thin plate member washing apparatus 500C will be described with reference to FIG. 15. FIG. 15 is a cross-sectional view of the thin plate member washing apparatus 500C in a state in which it has been assembled. Tap water (arrow W in FIG. 15) poured from the tap 1000 makes contact with the water flow plate 520 and is then spread out in the space A formed between the inner surface side of the lid 510 and the upper surface of the water flow plate 520.

The flow rate of the tap water flowing to the rotary supporting member 540C side is regulated by the number of water flow holes 520a provided in the water flow plate 520, and the flow of the tap water is divided into a plurality of streams, so that the flow of the tap water is spread over the entire surface of the water flow plate 520. Thus, the tap water showers down on the entire surface of the rotary supporting member 540C from the water flow holes 520a of the water flow plate 520.

The tap water showering down from the water flow holes 520a of the water flow plate 520 makes contact with the outer rotary blades 543 and the inner rotary blades 544 provided in the rotary supporting member 540C, thereby rotating the rotary supporting member 540C. Moreover, the tap water falling on the mesh member 160 held by the mesh member holding portion 545C flows over the front surface and the back surface of the mesh member 160 and washes down medicinal fluid residue and the like deposited on the mesh member 160. The medicinal fluid residue and the like deposited on the mesh member 160 are also washed down based on the centrifugal force due to rotation of the mesh member 160. The medicinal fluid residue and the like removed from the mesh member 160 is directly carried by the tap water and discharged to the outside of the thin plate member washing apparatus 500A through the fluid outlet opening 550a.

Effects

As described above, with the thin plate member washing apparatus 500C of the present embodiment, the mesh member 160 is washed by utilizing the force of flowing tap water to cause the tap water to shower down on the mesh member 160 while rotating the mesh member 160. Thus, the tap water can uniformly flow over the surface of the mesh member 160, and therefore, the mesh member 160 can be uniformly, efficiently, and easily washed. Moreover, quantitative and more uniform washing can be achieved by predetermining the tap water flow rate and the washing time.

Since the force of flowing tap water is utilized, the mesh member 160 can be rotated without using any other power. Moreover, since the removed medicinal fluid residue and the like are discharged to the outside along with the flowing water, the medicinal fluid residue and the like cannot be redeposited on the mesh member 160.

Moreover, water from the water tap does not directly strike the mesh member 160 and, therefore, cannot damage the mesh member 160, especially the metal thin plate member 161. Moreover, the mesh member 160 is held by the mesh member holding portion 545C provided inside the thin plate member washing apparatus 500C and, therefore, cannot be carried by the tap water down the drain and lost.

As described above, with the thin plate member washing apparatus 500C of the present embodiment, it is possible to efficiently wash a mesh member 160 without causing damage to the mesh member 160.

### Embodiment 4

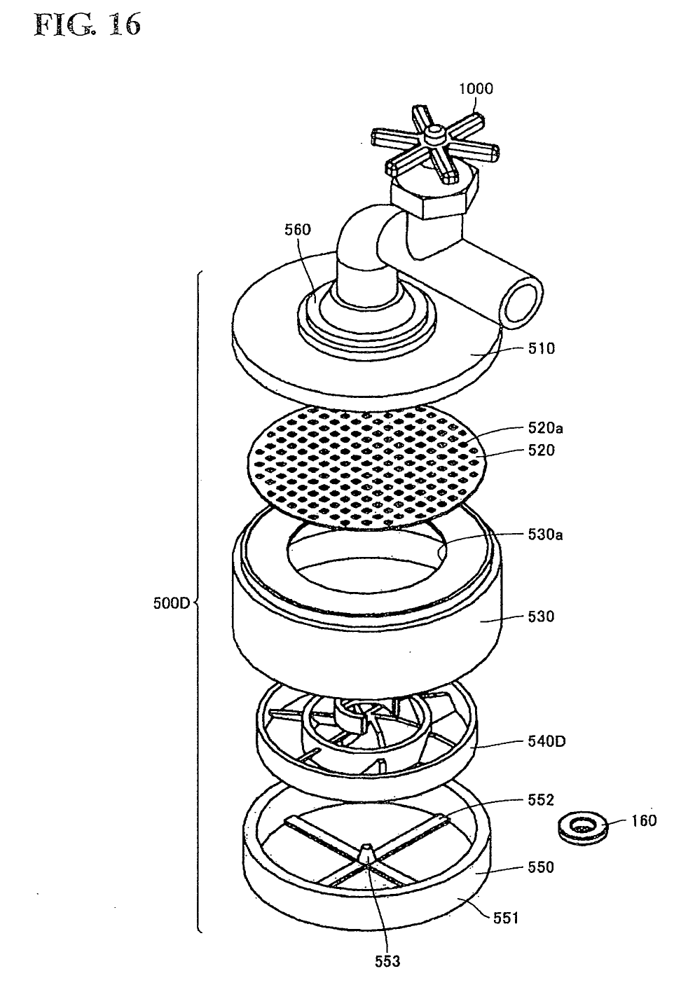

Next, the structure of a thin plate member washing apparatus 500D of Embodiment 4 according to the present invention will be described with reference to FIGS. 16 to 18. The thin plate member washing apparatus 500D of Embodiment 4 has the same basic configuration as the above-described thin plate member washing apparatus 500A of Embodiment 1. The two apparatuses are different in the number of mesh member holding portions fixed to the rotary supporting member.

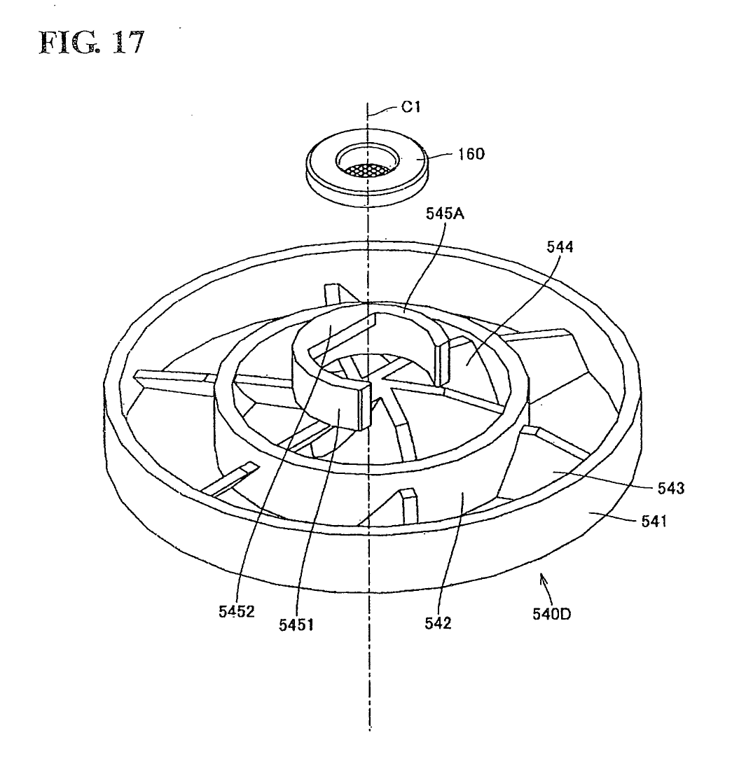

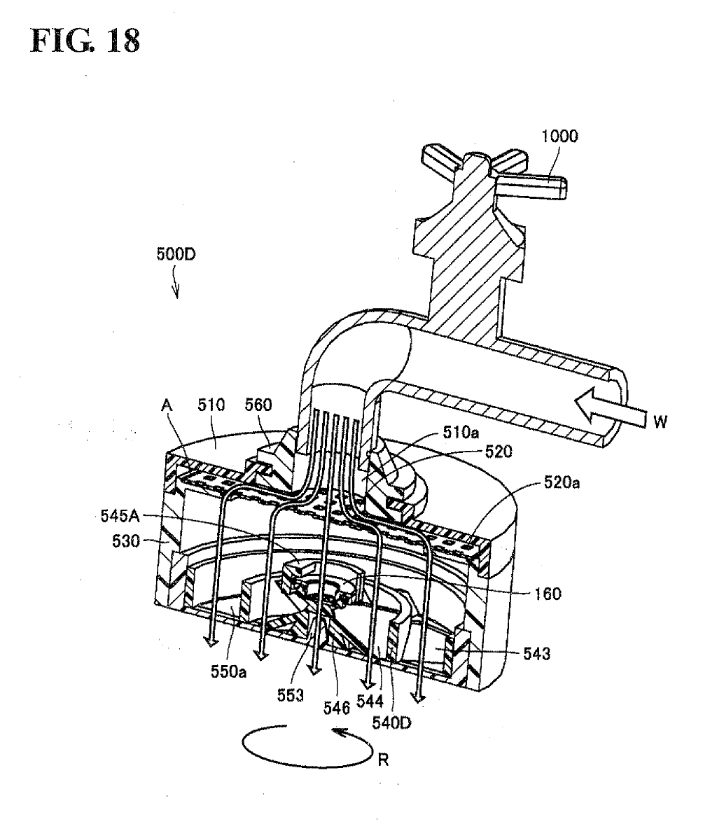

For this reason, in the drawings, the same components are denoted by the same reference numerals and duplication is eliminated, and only a mesh member holding portion 545A that is fixed to a rotary supporting member 540D employed in the thin plate member washing apparatus 500D of the present embodiment will be described. FIG. 16 is an exploded perspective view showing the configuration of the thin plate member washing apparatus 500D, FIG. 17 is a perspective view showing an arrangement of a mesh member and a rotary supporting member employed in the thin plate member washing apparatus 500D, and FIG. 18 is a vertical cross-sectional view of the thin plate member washing apparatus 500D.

Thin Plate Member Washing Apparatus 500D/Mesh Member Holding Portion 545A

As shown in FIGS. 16 and 17, in the rotary supporting member 540D of the present embodiment, a single mesh member holding portion 545A having the same form as that in Embodiment 1 is provided on the upper surface side of the inner rotary blades 544 at the center of the rotary supporting member 540D, in order to hold a mesh member 160 in a state in which a plane containing the mesh member 160 is perpendicular to the central axis of rotation C1 of the inner rotary blades 544.

Washing of Mesh Member 160

Next, washing of the mesh member 160 using the thin plate member washing apparatus 500D will be described with reference to FIG. 18. FIG. 18 is a cross-sectional view of the thin plate member washing apparatus 500D in a state in which it has been assembled. Tap water (arrow W in FIG. 18) poured from the tap 1000 makes contact with the water flow plate 520 and is then spread out in the space A formed between the inner surface side of the lid 510 and the upper surface of the water flow plate 520.

The flow rate of the tap water flowing to the rotary supporting member 540D side is regulated by the number of water flow holes 520a provided in the water flow plate 520, and the flow of the tap water is divided into a plurality of streams, so that the flow of the tap water is spread out over the entire surface of the water flow plate 520. Thus, the tap water showers down on the entire surface of the rotary supporting member 540D from the water flow holes 520a of the water flow plate 520.

The tap water showering down from the water flow holes 520a of the water flow plate 520 makes contact with the outer rotary blades 543 and the inner rotary blades 544 provided in the rotary supporting member 540D, thereby rotating the rotary supporting member 540D. The tap water falling on the mesh member 160 held by the mesh member holding portion 545A flows over the front surface and the back surface of the mesh member 160 based on the centrifugal force due to rotation of the mesh member 160 and removes medicinal fluid residue and the like deposited on the mesh member 160. The medicinal fluid residue and the like removed from the mesh member 160 are directly carried by the tap water and discharged to the outside of the thin plate member washing apparatus 500D through the fluid outlet opening 550a.

Effects

As described above, with the thin plate member washing apparatus 500D of the present embodiment, the mesh member 160 is washed by utilizing the force of flowing tap water to cause the tap water to shower down on the mesh member 160 while rotating the mesh member 160. Thus, the tap water can uniformly flow over the surface of the mesh member 160, and therefore, the mesh member 160 can be uniformly, efficiently, and easily washed. Moreover, quantitative and more uniform washing can be achieved by predetermining the tap water flow rate and the washing time.

Since the force of flowing tap water is utilized, the mesh member 160 can be rotated without using any other power. Moreover, since the removed medicinal fluid residue and the like are discharged to the outside along with the flowing water, the medicinal fluid residue and the like cannot be redeposited on the mesh member 160.

Moreover, water from the water tap does not directly strike the mesh member 160 and, therefore, cannot damage the mesh member 160, especially the metal thin plate member 161. Moreover, the mesh member 160 is held by the mesh member holding portion 545A provided inside the thin plate member washing apparatus 500D and, therefore, cannot be carried by the tap water down the drain and lost.

As described above, with the thin plate member washing apparatus 500D of the present embodiment, it is possible to efficiently wash a mesh member 160 without causing damage to the mesh member 160.

Although the above embodiments have been described using the mesh member 160 for use in nebulizers as an example of the thin plate member to be washed, the thin plate member that can be used for the thin plate member washing apparatus according to the present invention is not limited to the mesh member for use in nebulizers, and the present invention is applicable to contact lenses and other thin plate members as well.

Although there have been described particular embodiments of the present invention, the embodiments disclosed herein are to be considered in all respects as illustrative and not restrictive. The scope of the present invention is defined by the appended claims, and all changes that fall within the meaning and scope equivalent to those of the claims are intended to be embraced therein.

### REFERENCE SIGNS LIST

100 nebulizer
110 nozzle
120 open/close operation portion
130 medicinal fluid storage portion
140 stepped horn
150 piezoelectric element
160 mesh member
161 thin plate member
162 resin member
180 fluid collecting portion
190 partition plate
200 mouthpiece
210 atomizer-side opening
211 flange portion
220 inhalation port
230 air intake
240 tubular portion
500A thin plate member washing apparatus
510 lid
510a fluid inlet opening
520 water flow plate
530 cap
530a opening
520a water flow hole
540A, 540B, 540C, 540D rotary supporting member
541 outer circumferential ring-shaped side wall
542 inner circumferential ring-shaped side wall
543 outer rotary blade
544 inner rotary blade
545A, 545B, 545C mesh member holding portion
5451 ring portion
5452 retaining portion
5453 groove portion
5454 side wall portion
5455 sloping support portion
546 rotation shaft receiving recess
550 bottom cap,
550a fluid outlet opening
551 ring-shaped side wall
552 bridge
553 rotation shaft
560 rubber gasket
1000 tap
A space
C1 central axis

1. A thin plate member washing apparatus comprising:
a housing that includes a fluid inlet opening through which a fluid can be introduced and a fluid outlet opening;
a thin plate member holding portion that is housed inside the housing and holds a thin plate member whose surface can be washed with the fluid; and
a rotary supporting member that is housed inside the housing, supports the thin plate member holding portion, and is rotated by the fluid passing therethrough.

2. The thin plate member washing apparatus according to claim 1, wherein the rotary supporting member has rotary blades that obtain a rotational force from the fluid passing the rotary blades.

3. The thin plate member washing apparatus according to claim 1, further comprising a fluid flow rate regulator that regulates a flow rate of the fluid flowing to the rotary supporting member, between the fluid inlet opening and the thin plate member holding portion.

4. The thin plate member washing apparatus according to claim 1, further comprising a fluid path separator that divides the fluid flowing to the rotary supporting member into a plurality of streams, between the fluid inlet opening and the thin plate member holding portion portion.

5. The thin plate member washing apparatus according to claim 1, further comprising a fluid path spreader that spreads the fluid flowing to the rotary supporting member, between the fluid inlet opening and the thin plate member holding portion.

6. The thin plate member washing apparatus according to claim 1, wherein a water tap can be connected to the fluid inlet opening.

7. The thin plate member washing apparatus according to claim 1, wherein the thin plate member is a mesh member composed of a metal thin plate member in which multiple minute holes are formed.
